(19) United States
(12) Patent Application Publication
(10) Pub. No.: US 2006/0017649 A1
(43) Pub. Date: Jan. 26, 2006

(54) Helical antenna with integrated notch filter

(76) Inventors: Sooliam Ooi, Plantation, FL (US); Alexis V. Nogueras, Miami, FL (US)

Correspondence Address: MOTOROLA, INC., 1303 EAST ALGONQUIN ROAD, IL01/3RD, SCHAUMBURG, IL, 60196, US

(21) Appl. No.: 10/887,729

(22) Filed: Jul. 9, 2004

(51) Int. Cl. H01Q 1/36

(52) U.S. Cl. 343/895

(57) ABSTRACT

A helical antenna (100) forming an integrated notch filter includes a first helical radiating element (101) attached to a second helical radiating element (103). The second helical radiating element is one quarter wavelength of a resonant operating frequency. The helical antenna (100) forms a notch filter through the use of intrinsic capacitance and inductance in both radiating elements. The invention provides an integrated notch filter for attenuating a predetermined range of radio frequency (RF) signals presented to the helical antenna (100) without the use of discrete circuit components.

### TECHNICAL FIELD

This invention relates in general to an antenna and more particularly to a helical antenna with integrated notch filter used with a portable two-way radio for mitigating out of band interference.

### BACKGROUND

Portable radio equipment is commonly used for many public service applications such as police, fire and other governmental service organizations. These public service organizations often operate in a licensed radio spectrum typically in the 800-900 MHz range. Typically, this spectrum is very crowded not only with public safety applications but also with commercial vendors offering cellular telephone services. This often creates a problem with portable radio equipment used by public safety users since the strong cellular signals from powerful cell sites and the like create strong intermodulation distortion products associated with their own radio frequency signals. These distortion products can interference with the receiver in the portable radio and may at times render the radio useless. This occurs since the radio receiver front end circuitry becomes overloaded from the strong off-channel interference, rendering it unable to receive incoming voice or data.

One way to reduce and/or eliminate the incoming distortion products caused by adjacent channel interference is through the use of discrete filters used in connection with incoming signals at the front end of the radio receiver. One application of this technology is to directly filter the incoming interfering signals at the radio antenna. Prior art designs have incorporated filters with the antenna by using discrete components in a circuit board design that is built into the antenna. Although this solution helps to attenuate incoming distortion products at the receiver, this is an expensive solution. The antenna must use a special design which incorporates discrete circuit components such as inductors and capacitors that form the discrete filter. Moreover, the components integrated with these filers often are not capable of handling the high transmitter power requirements for a given portable radio. This causes the filter circuit components to ultimately fail, requiring expensive repair or replacement of the antenna.

Consequently, the need exists to provide an inexpensive antenna design which incorporates a filter that can effectively reduce incoming radio frequency distortion products from strong adjacent channel interferers.

### SUMMARY OF THE INVENTION

Briefly, according to the invention, there is provided a two-pitch helical antenna with center feeding where the antenna's shape effectively forms a notch filter used for filtering distortion products from the front end of a portable communications receiver. The antenna includes a helical element positioned above a feed point that is tuned to a passband frequency. The electrical length of the helical element is a quarter wavelength, half wavelength, or appropriately tuned such that it synthesizes the passband characteristic of a 50 ohm terminated parallel tuned circuit for the desired passband. The helical element below the feed point should provide a short circuit condition as the desired stop band frequencies are either an open ended quarter wave in electrical length or shortened half wave length in electrical length. Both elements form a second order notch filter.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings in which like reference numerals identify like elements, and in which:

FIG. 1 is a front elevational view of the helical antenna with integrated notch filter according to the preferred embodiment of the invention.

FIG. 2 is a close-up elevational view of the helical antenna illustrating the pitch length and wire diameter of the radiating element as seen in FIG. 1.

FIG. 3 is a top view of the helical antenna illustrating the helix diameter of the radiating element as seen in FIG. 1.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

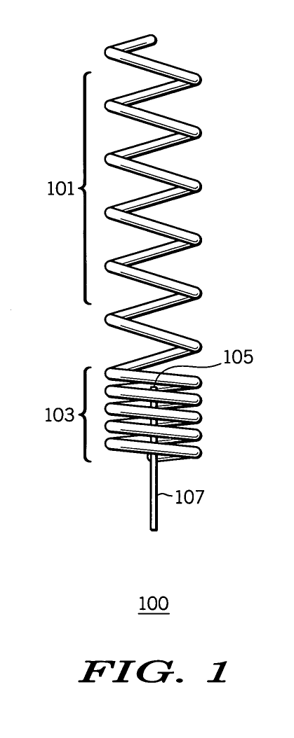

Referring now to FIG. 1, the helical antenna with integrated notch filter 100 includes a main helical radiating element 101. The radiating element 101 is a tuned element that offers both a tuned inductance formed by the coil of the radiation and a tuned capacitance formed by the distance between the metallic radiating elements. This distributed inductance and capacitance work to form a tuned notch filter operating at some predetermined frequency. As will be recognized by those skilled in the art, the notch filter works to reduce and/or eliminate a predetermined range of frequencies that present themselves at the antenna 100.

An open ended quarter wavelength helical resonator 103 is attached at the proximal end of the radiating element 101. The quarter wavelength helix resonator 103 is a coil formed with and connected to the radiating element 101 that works to match the radiating element 103 to a feed point 105. The feed point 105 connects with a feedline or stripline connection 107 that can be either directly or parasitically coupled to the feed point 105. Preferably, the feed point 105 should match a 50 ohm non-reactive load impedance.

The helical antenna 100 offers a number of distinct advantages of prior art antenna systems since the intrinsic characteristics of the helical radiating element 101 provides a frequency response of a second order band stop filter. This configuration creates a shunt helix resonator in the radiating element 101 with a quarter wave helix 103. Both the radiating element 101 and the helix resonator 103 operate to attenuate a specific range of interfering frequency spectrum enabling the radio receiver to operate normally without being overloaded from adjacent channel interference in the same frequency spectrum. Moreover, since no discrete components are used in connection with the notch filter, the antenna is capable of accommodating power levels at and above 5 watts without the burden and expense of failing filter components.

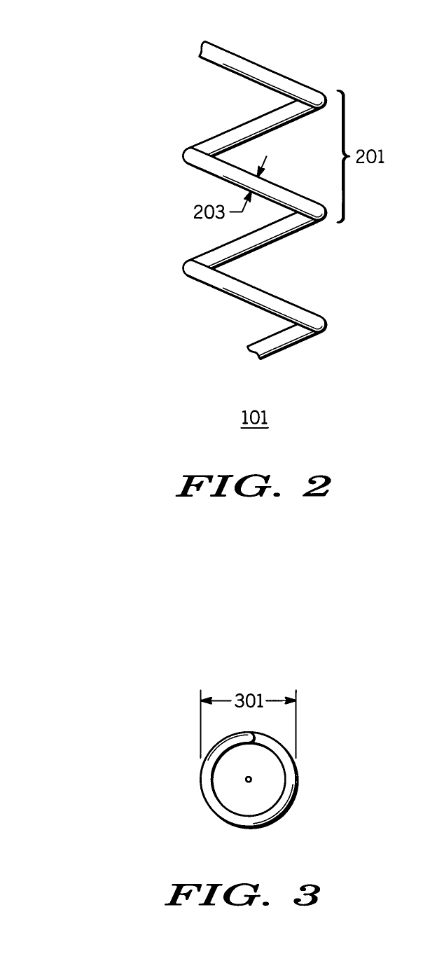

As seen in FIGS. 2 and 3, the radiating element 101 includes a period length 201 and a wire diameter 203. FIG. 3 illustrates a top view of the radiating element where the helix diameter 301 of the helix is shown. The resonant frequency of the integrated notch filter 100 uses the period length 201, diameter 203 and helix diameter 301.

Thus, the invention provides an inexpensive antenna helical design that incorporates an integrated filter using non-discrete components that effectively reduces incoming radio frequency distortion products from strong adjacent channel interferers.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A helical antenna forming an integrated notch filter comprising:
a first helical radiating element;
a second helical radiating element connected to the first helical radiating element that is one quarter wavelength of a resonant operating frequency; and
wherein the first helical radiating element and the second helical radiating element both form a notch filter without the use of discrete circuit components for attenuating a range of predetermined radio frequency signals presented to the antenna.

2. A helical antenna forming an integrated notch filter as in claim 1, wherein the first helical radiating element includes both a distributed inductance and capacitance.

3. A helical antenna forming an integrated notch filter as in claim 1, wherein the second helical radiating element includes both a distributed inductance and capacitance.

4. A helical antenna forming an integrated notch filter as in claim 1, wherein the notch filter emulates the frequency response of a second order band stop filter.

5. A helical antenna forming an integrated notch filter as in claim 1, wherein the second helical radiating element forms a matching section for matching the antenna to a 50 ohm load impedance.

6. A two-pitch helical antenna that incorporates a notch filter for attenuating unwanted adjacent channel interference in a portable two-way communications device comprising:
a first helical radiating element for providing a first distributed inductance and capacitance based on the physical characteristics of the first helical radiating element;
a second helical radiating element connected to first helical radiating element for providing a second distributed inductance and capacitance based on the physical characteristics of the second helical radiating element; and
wherein the first distributed inductance and capacitance and the second distributed inductance and capacitance form a notch filter for attenuating a predetermined range of frequency spectrum without the use of discrete electrical components.

7. A helical antenna as in claim 6, wherein the first helical radiating element is longer in overall length than the second helical radiating element.

8. A helical antenna as in claim 6, wherein the second helical radiating element also forms a quarter wave matching stub for a predetermined operating frequency in order to match the helical antenna to a 50 ohm load impedance.

9. A helical antenna as in claim 6, wherein the notch filter emulates the frequency response of a second order band stop filter.

10. A helical antenna as in claim 6, wherein a feedline connects the two-way communications device to the helical antenna at a predetermined location on the second helical resonator.

11. A method for providing an integrated notch filter within a helical antenna without using discrete electrical components comprising the steps of:
forming a first helical resonator with a predetermined distributed inductance and capacitance;
forming a second helical resonator connected to the first helical resonator with a predetermined distributed inductance and capacitance;
providing a feed point at a predetermined location on the second helical resonator; and
adjusting the first helical resonator and second helical resonator so as to form a notch filter for eliminating a range of interfering radio frequency signals presented to the helical antenna.

12. A method for providing an integrated notch filter as in claim 11, wherein the first helical resonator is longer in length than the second helical resonator.

13. A method for providing an integrated notch filter as in claim 11, wherein the notch filter emulates the response of a second order band stop filter.

14. A method for providing an integrated notch filter as in claim 11, wherein the second helical resonator is tuned to operate at one quarter wavelength of the operating frequency.

15. A method for providing an integrated notch filter as in claim 11, wherein the helical antenna is fed at a predetermined location on the second helical resonator for matching a substantially 50 ohm impedance.
